(19) United States
(12) Patent Application Publication
(10) Pub. No.: US 2023/0384745 A1
(43) Pub. Date: Nov. 30, 2023

(54) METHOD FOR CONTROLLING LEGACY SYSTEM BASED ON CHATBOT SERVICE

(71) Applicant: SAMSUNG SDS CO., LTD., Seoul (KR)

(72) Inventors: Seong Su KIM, Seoul (KR); Da Han JEONG, Seoul (KR)

(73) Assignee: SAMSUNG SDS CO., LTD., Seoul (KR)

(21) Appl. No.: 18/203,393

(22) Filed: May 30, 2023

(30) Foreign Application Priority Data
May 31, 2022 (KR) 10-2022-0066527

(51) Int. Cl. G05B 15/02

(52) U.S. Cl. CPC G05B 15/02

(57) ABSTRACT

Methods and apparatuses for controlling a legacy system based on a chatbot service, performed in a computing system are provided. The method may comprise receiving legacy system selection information indicating that a first legacy system is selected as a control target legacy system, from a user terminal through a chatbot service, receiving control details for the first legacy system from the user terminal through the chatbot service, transmitting information on the control details to a manager terminal, and transmitting an execution request of the control details to the first legacy system only when an approval signal is received from the manager terminal and receiving an execution result of the control details from the first legacy system, and outputting a chatbot message of the execution result through the chatbot service.

### CROSS-REFERENCE TO RELATED APPLICATION

This application claims priority from Korean Patent Application No. 10-2022-0066527 filed on May 31, 2022 in the Korean Intellectual Property Office and all the benefits accruing therefrom under 35 U.S.C. 119, the contents of which in its entirety are herein incorporated by reference.

### BACKGROUND

### Technical Field

The present disclosure relates to a method for controlling a legacy system based on a chatbot service, and more particularly, to a method for supporting a person in charge of a legacy system to easily control the legacy system through a chatbot service regardless of a location and a situation, and a system to which the method is applied.

### Description of the Related Art

A legacy system operating within a company is connected to a closed network distinguished from an external network by one or more firewalls for security. For security reasons, a terminal of a person in charge of managing the legacy system is also often required to be connected to the closed network. Therefore, even though a failure issue with respect to the legacy system occurs in a situation where the person in charge is not in the company, it is difficult to take an immediate action.

Therefore, it is required to provide a method for controlling a legacy system to easily access the legacy system anywhere and anytime for efficient and effective system operation and suppress occurrence of a security vulnerability to the legacy system.

### SUMMARY

An object of the present disclosure is to provide method for controlling a legacy system through a common channel even though a person in charge of the legacy system uses any user terminal at any location, and a system to which the method is applied.

Another object of the present disclosure is to provide a method for controlling a legacy system through a common channel regardless of a network to which a user terminal of a person in charge of the legacy system is connected, and a system to which the method is applied.

Still another object of the present disclosure is to provide a method for controlling a legacy system to which a different level of security action is applied depending on a network to which a user terminal of a person in charge of the legacy system is connected, and a system to which the method is applied.

Further still another object of the present disclosure is to provide a method for controlling a legacy system to which a security action of a level according to security of the legacy system, which is a control target, or sensitivity in view of management of the overall system is applied, and a system to which the method is applied.

Further still another object of the present disclosure is to provide a method for controlling a legacy system, which provides an interface for inputting control details to accurately control a control target legacy system even through a chatbot service, and a system to which the method is applied.

Further still another object of the present disclosure is to provide a method for controlling a legacy system capable of accurately identifying a control result of a control target legacy system even through a chatbot service, and a system to which the method is applied.

The objects of the present disclosure are not limited to those mentioned above and additional objects of the present disclosure, which are not mentioned herein, will be clearly understood by those skilled in the art from the following description of the present disclosure.

According to an aspect of the inventive concept, there is provided a method for controlling a legacy system based on a chatbot service, performed in a computing system. The method may comprise receiving legacy system selection information indicating that a first legacy system is selected as a control target legacy system, from a user terminal through the chatbot service, receiving control details for the first legacy system from the user terminal through the chatbot service, transmitting information on the control details to a manager terminal, and transmitting an execution request of the control details to the first legacy system only when an approval signal is received from the manager terminal and receiving an execution result of the control details from the first legacy system, and outputting a chatbot message of the execution result through the chatbot service.

In some embodiments, the transmitting the execution request of the control details to the first legacy system may include determining whether the first legacy system satisfies a predefined manager forced confirmation requirement, transmitting the information on the control details to the manager terminal when the control target legacy system satisfies the predefined manager forced confirmation requirement, and transmitting the execution request of the control details to the first legacy system only when the approval signal is received from the manager terminal and transmitting the execution request of the control details to the first legacy system when the control target legacy system does not satisfy the predefined manager forced confirmation requirement.

In some embodiments, the determining whether the first legacy system satisfies the predefined manager forced confirmation requirement may include determining that the first legacy system does not satisfy the predefined manager forced confirmation requirement when the user terminal is connected to a closed network.

In some embodiments, the determining whether the first legacy system satisfies the predefined manager forced confirmation requirement may include checking an attribute as to checking of a chatbot-based control manager among attributes of the first legacy system from configuration information and as a result of checking, when the attribute as to checking of the chatbot-based control manager of the first legacy system has a pre-designated value, determining that the first legacy system satisfies the predefined manager forced confirmation requirement.

In some embodiments, the outputting the chatbot message of the execution result through the chatbot service may include transmitting a message reporting the execution result to a terminal of the manager.

In some embodiments, the determining whether the first legacy system satisfies the predefined manager forced confirmation requirement may include checking whether a user of the user terminal has a control authority for the first legacy system by using user information of the chatbot service and determining whether the first legacy system satisfies the predefined manager forced confirmation requirement only when the user of the user terminal has the control authority for the first legacy system.

In some embodiments, the first legacy system may be a system connected to a closed network distinguished from an external network, to which the user terminal connected to the chatbot service is connected, by one or more firewall systems.

In some embodiments, the first legacy system may be a system connected to a closed network, and the receiving the control details for the first legacy system may include determining whether the user terminal connected to the chatbot service is connected to an external network distinguished from the closed network by one or more firewall systems, performing 2-factor authentication (2FA) for the user terminal when the user terminal is connected to the external network and outputting an error message through the chatbot service when it is determined that the 2FA is failed.

In some embodiments, the performing the 2FA for the user terminal may include skipping the 2FA when the user terminal is connected to the closed network.

In some embodiments, the receiving the control details for the first legacy system may include receiving a selection input for the first legacy system through the chatbot service as a response to display of a list of a plurality of connectable legacy systems through the chatbot service.

According to another aspect of the inventive concept, there is provided a method for controlling a legacy system based on a chatbot service, performed in a computing system. The method may comprise providing a card generation interface for registering a card type chatbot interface for receiving control details for a first legacy system to a user terminal, providing the registered card type chatbot interface on the chatbot service in response to receiving the control details for the first legacy system from the user terminal through the chatbot service, transmitting control details description data generated using information input from the user terminal, to the first legacy system through the card type chatbot interface and receiving an execution result of the control details described in the control details description data from the first legacy system and outputting a chatbot message of the execution result through the chatbot service.

In some embodiments, the card type chatbot interface may be an adaptive card type interface represented by JavaScript Object Notation (JSON) and rendered by a client application of the chatbot service.

In some embodiments, the providing the registered card type chatbot interface on the chatbot service may include providing any one of card type chatbot interfaces registered by a user of the user terminal on the chatbot service with the user of the user terminal.

In some embodiments, the card generation interface may include an application programming interface (API) selection area for designating an API to be bound to the card type chatbot interface, among one or more APIs pre-registered with respect to the first legacy system, one or more APIs pre-registered with respect to the first legacy system is provided by the first legacy system, and a system providing the chatbot service is pre-registered as an API call-enabled system.

In some embodiments, the providing the card generation interface for registering the card type chatbot interface to the user terminal may include displaying a generation interface of an execution result binding card for registering the card type chatbot interface generated as the chatbot message of the execution result when an API of an execution result binding type is selected through the API selection area.

In some embodiments, the providing the card generation interface for registering the card type chatbot interface to the user terminal may include displaying an interface for receiving one or more variables for defining a capture screen for the execution result when an API of a capture type is selected through the API selection area.

In some embodiments, the outputting the chatbot message of the execution result through the chatbot service may include outputting the chatbot message of the execution result including a download button of a download file with respect to the execution result when an API of an execution result download type is selected through the API selection area.

In some embodiments, the card generation interface for registering the card type chatbot interface may include an execution result type selection area for designating a type indicating the execution result of the API selected through the API selection area as one of an execution result binding type, a capture type and an execution result download type, the execution result binding type is a type in which an execution result binding card to which a return value of the selected API is bound is generated as the chatbot message of the execution result, the capture type is a type in which a capture screen of an execution result screen of the selected API on the first legacy system is generated as the chatbot message of the execution result, and the execution result download type is a type in which a button capable of downloading a file in which data generated as an execution result of the selected API is written is included in the chatbot message of the execution result.

According to still another aspect of the inventive concept, there is provided a control system of a legacy system. The control system may comprise one or more legacy systems in which a chatbot service system is registered as a control permission system capable of transmitting information on control details and a chatbot service system configured to perform a dialogue for selecting a control target legacy system among the one or more legacy systems, display a card type chatbot interface for receiving control details for the selected control target legacy system, transmit information on the control details to a manager terminal of a first legacy system when the first legacy system is selected as the control target legacy system, transmit an execution request of the control details to the first legacy system only when an approval signal is received from the manager terminal, receive an execution result of the control details from the first legacy system, and output a chatbot message of the execution result through a chatbot service.

In some embodiments, the one or more legacy systems may be systems connected to a closed network connected to an external network by one or more firewall systems, and the chatbot service system may be a system connected to the closed network.

In some embodiments, the chatbot service system may determine whether a user terminal connected to the chatbot service is connected to the closed network, and performs 2-factor authentication (2FA) for the user terminal when the user terminal is not connected to an external network.

In some embodiments, the chatbot service system may determine whether a user of a user terminal has a control authority for the first legacy system, by using user information of the chatbot service, and determine whether the first legacy system satisfies a predefined manager force confirmation requirement only when the user of the user terminal has the control authority for the first legacy system.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic view illustrating a control system of a legacy system according to one embodiment of the present disclosure;

FIG. 2 is a flow chart illustrating a method for controlling a legacy system based on a chatbot service according to another embodiment of the present disclosure;

FIGS. 3 to 5 are detailed flow charts illustrating a partial operation of a method described with reference to FIG. 2;

FIGS. 6 and 7 are views illustrating an exemplary card type chatbot interface that may be displayed in a user terminal as a result of some embodiments of the present disclosure, which are performed;

FIG. 8 is a view illustrating a card generation interface that may be displayed in a user terminal as a result of some embodiments of the present disclosure, which are performed;

FIGS. 9 to 12 are views illustrating an exemplary chatbot message of an execution result that may be displayed in a user terminal as a result of some embodiments of the present disclosure, which are performed; and

FIG. 13 is a hardware schematic view illustrating a computing system described in some embodiments of the present disclosure.

### DETAILED DESCRIPTION OF THE DISCLOSURE

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

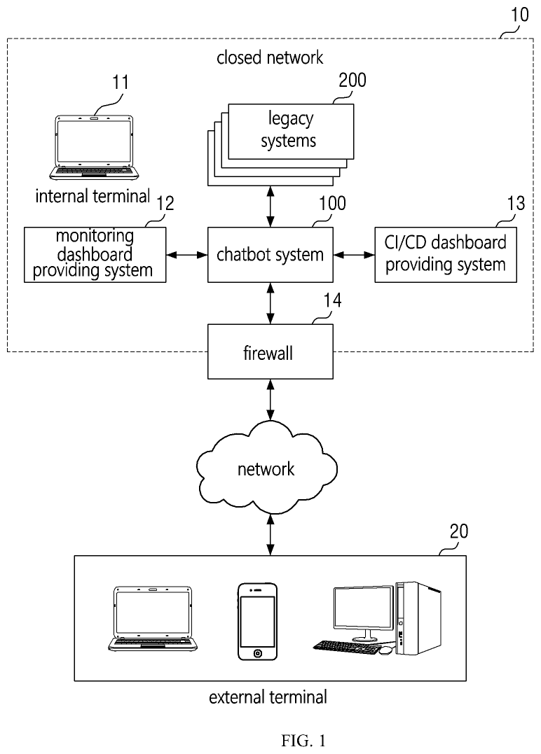

First, a control system of a legacy system according to an embodiment of the present disclosure will be described with reference to FIG. 1. The control system of the legacy system according to the present embodiment may be understood as a system that supports one or more control target legacy systems to be controlled by using a user terminal. Hereinafter, ‘the control system of the legacy system’ will be abbreviated as ‘a control system’ through the present disclosure.

In the present disclosure, it is to be understood that ‘the legacy system’ is a system, which is a control target, in accordance with a user input that is input to the user terminal. The legacy system is not limited to performing a specific function.

As shown in FIG. 1, the control system according to the present embodiment may include a chatbot system 100 and legacy systems 200. In addition, the control system according to the present embodiment may further include a monitoring dashboard providing system 12 that provides dashboard information on the legacy systems 200 to the chatbot system 100 and a continuous integration/continuous deployment (Cl/CD) providing system 13 that provides dashboard information related to Cl/CD to the chatbot system 100. Although the control system according to the present embodiment is shown as including a plurality of components 12, 13, 14, 100, and 200, which are distinguished from one another, in FIG. 1, at least some of the components shown in FIG. 1 may be implemented as separate software modules in the same physical server as that of the other components.

As shown in FIG. 1, the chatbot system 100 may be connected to a closed network 10 together with the legacy systems 200. Since the closed network 10 may be connected to an external network through the firewall system 14, indiscriminate packet inflow from the outside into the closed network 10 may be avoided. Since the chatbot system 100 is connected to the inside of the closed network 10, restrictions of low level may be applied to the connection to the legacy system 200 as compared with devices positioned outside the closed network.

However, the legacy systems 200 may not allow indiscriminate access of devices even though the devices are connected into the closed network 10, but may only allow access to the devices connected into the closed network 10 as pre-registered devices. In this case, the chatbot system 100 may be included in a list of access permission devices of the legacy system, which are only allowed to the pre-registered devices among the legacy systems 200.

The chatbot system 100 may be understood as a computing system that provides a chatbot service, and may be associated with an external general purpose instant messenger service system (not shown) or a company instant messenger service system (not shown), which manages the closed network 10, to provide the chatbot service. The chatbot system 100 is connected to the closed network 10, however, not only an internal terminal 11 connected to the inside of the closed network 10, but also an external terminal 20 connected to the outside of the closed network 10 may be also connected to the chatbot system 100.

Hereinafter, in the present disclosure, it is assumed that the internal terminal 11 and the external terminal 20 are user terminals used by a person in charge of responding to issues of one or more legacy systems. That is, even though the person in charge of the legacy system uses any user terminal at any location, it is possible to control the legacy system through a common channel called a chatbot regardless of whether the network to which the user terminal of the person in charge of the legacy system is connected is the closed network 10 or Internet or a mobile communication network.

Also, the control system according to the present embodiment may apply a different level of security action based on the network to which the user terminal of the person in charge of the legacy system is connected, security of the legacy system, which is the control target, or sensitivity in view of management of the overall system, beyond providing a common channel of a legacy system control, which is called a chatbot. Therefore, even though the person in charge of the legacy system rapidly controls the legacy systems 200 by using the external terminal 20 such as a smartphone, a precaution action may be taken such that an additional failure is not generated in the operation of the legacy systems 200. Hereinafter, the description will be given in more detail.

The chatbot system 100 receives legacy system selection information indicating that a first legacy system is selected as a control target legacy system, from the user terminal of the person in charge through the chatbot service. In addition, the chatbot system 100 receives control details for the first legacy system from the user terminal of the person in charge through the chatbot service.

In this case, the chatbot system does not immediately transmit an execution request of the control details to the first legacy system, but may transmit the execution request of the control details to the first legacy system only when information on the control details is transmitted to a manager terminal and an approval signal is received from the manager terminal. That is, in a situation where a legacy system control is performed through a channel, which is called a chatbot and enables a prompt response, the control system according to the present embodiment may block the cause of occurrence of additional failure by additionally verifying the manager of the legacy system.

Also, the control system according to the present embodiment may provide an interface for inputting control details, which enables accurate control of the control target legacy system even through the chatbot service. The interface for inputting control details may be a card type chatbot interface for receiving control details for the first legacy system. The card type chatbot interface may be an adaptive card type interface that is represented by JavaScript Object Notation (JSON) and is rendered by a client application of the chatbot service. A detailed description of the ‘adaptive card’ may be made with reference to a web document (https://adapativecard.io/).

Hereinafter, the card type chatbot interface will be referred to as an adaptive card, which is its example, to assist understanding of the present disclosure.

That is, new technical spirits that the legacy system may be accurately controlled even through the chatbot by specifying the control details for the legacy system through the adaptive card are applied to the control system according to the present embodiment. The execution result of the legacy system according to the control details may be also expressed on the chatbot service through the above adaptive card, so that the execution result of the legacy system may be accurately and intuitively identified even in the chatbot service.

The detailed operation of the control system according to the present embodiment will be more clearly understood with further reference to the description of an embodiment related to a method for controlling a legacy system based on a chatbot service, which will be described later, and the technical spirits of the embodiment related to the method for controlling a legacy system based on a chatbot service, which will be described later, is naturally applicable to the control system according to the present embodiment.

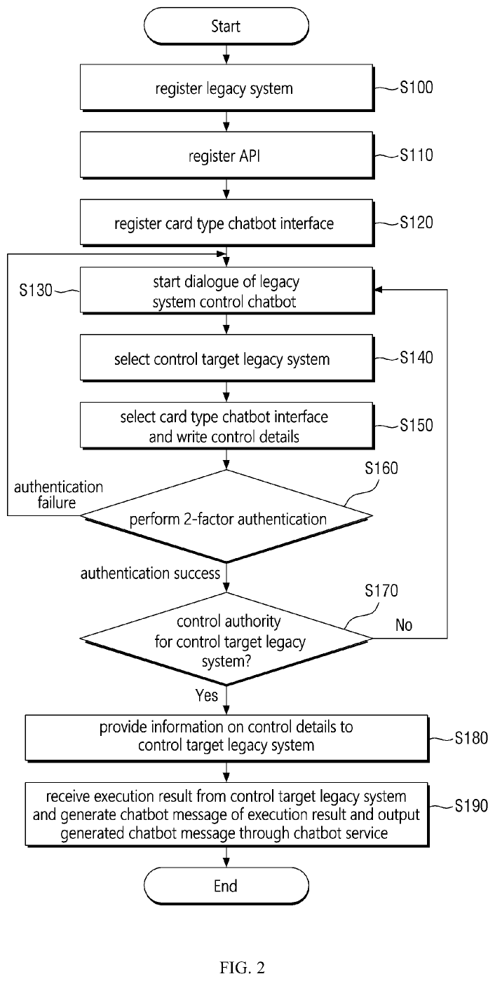

Next, the method for controlling a legacy system based on a chatbot service according to another embodiment of the present disclosure will be described with reference to FIGS. 2 to 12. Hereinafter, the ‘method for controlling a legacy system based on a chatbot service’ according to the present embodiment will be abbreviated as a ‘control method’.

The control method according to the present embodiment may be performed by one or more computing devices. That is, all operations may be performed by one computing device or some operations may be performed by another computing device. For example, some operations may be performed by a first server system, and other operations may be performed by a second server system.

In addition, as the server system is implemented on a cloud computing node, operations performed by one server system may be also divisionally performed on a plurality of cloud computing nodes. Hereinafter, in describing the control method according to the present embodiment, a description of a subject, which performs some operations, may be omitted, and in this case, the subject may be the chatbot system 100 described with reference to FIG. 1.

The description will be given with reference to FIG. 2.

First, as a registration procedure for chatbot-based control of the legacy system, registration S100 for a control target legacy system, registration S110 for an Application Programming Interface (API) provided by each control target legacy system, and registration S120 of a card type chatbot interface for inputting control details for the control target legacy system may be performed.

In a process of the registration S100 for the control target legacy system, access information such as IP address and port information of the legacy system and at least one of password information such as ID/PW or authentication information of authentication token may be stored in the chatbot system.

Also, in a process of the registration S110 for the API, name and parameter information of the API may be stored in the chatbot system. In some embodiments, in the process of the registration S110 for the API, type information of the API may be further stored in the chabot system. The type of the API indicates which type of execution result of the API is displayed on the chatbot service, and the type information of the API may be any one of an execution result binding type, a capture type, and an execution result download type.

When the API of the execution result binding type is called, an adaptive card in which a variable value returned as a result of the API execution is bound to each corresponding field may be displayed as an execution result chatbot message.

In addition, when the API of the capture type is selected, a capture screen for the execution result of the API may be displayed as the execution result chatbot message.

Also, when the API of the execution result download type is selected, a download link of a download file for the execution result may be displayed as the execution result chatbot message.

In a process of the registration S120 of the card type chatbot interface, one adaptive card to be applied to the control target legacy system may be registered. That is, the legacy system and the adaptive card may correspond to each other in one-to-one correspondence. That is, control for a specific legacy system may minimize the possibility of a user to perform a wrong control by mistake by using only one adaptive card.

In the process of the registration S120 of the adaptive card, a plurality of adaptive cards to be applied to the control target legacy system may be registered. That is, after selecting the control target legacy system on the chatbot service, the user may select any one of a plurality of pre-registered adaptive cards to control the selected legacy system, thereby inputting optimal control details according to the situation.

Also, in some embodiments, the registration S120 of the card type chatbot interface may be personalized. That is, the user may use only the adaptive card registered by himself/herself. Therefore, the user may control the legacy system by using only the adaptive card most familiar to himself/herself as a card type chatbot interface registered by himself/herself, thereby minimizing the possibility of wrong legacy system control.

As a registration procedure for chatbot-based control of the legacy system, the registration S100 for the control target legacy system, the registration S110 for the API provided by each control target legacy system, and the registration S120 of the card type chatbot interface for inputting control details for the control target legacy system have been described as above. To assist understanding, the description will be given in more detail with reference to related drawings.

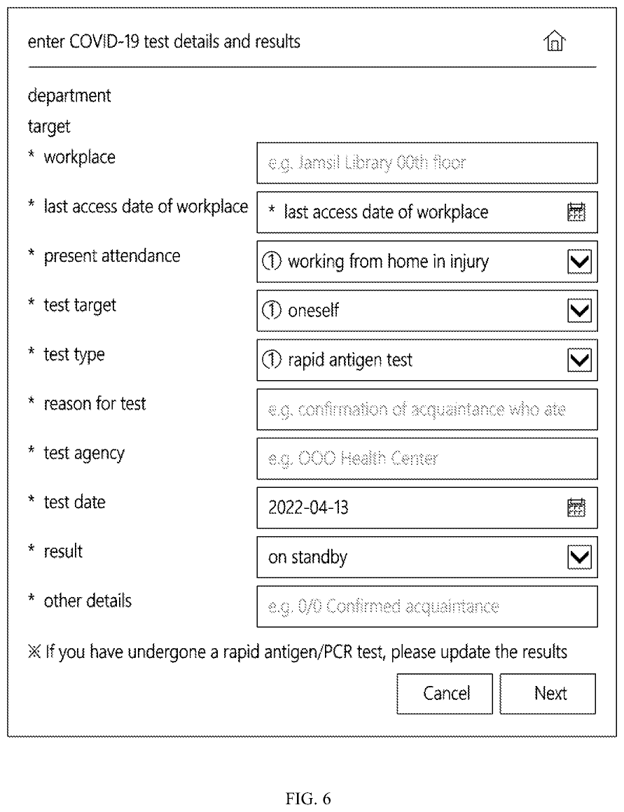

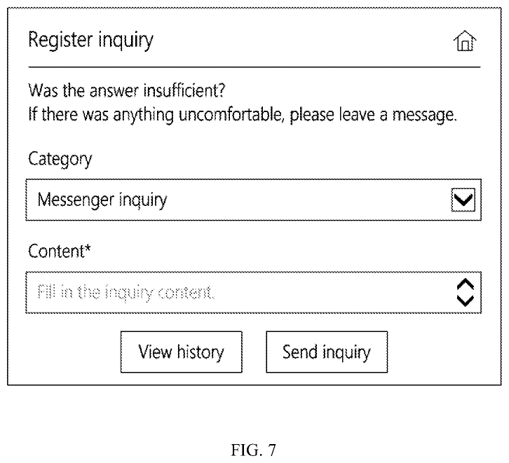

FIGS. 6 and 7 are views illustrating examples of the above-described adaptive card, FIG. 6 illustrates an exemplary adaptive card for receiving a plurality of field values, and FIG. 7 illustrates an exemplary adaptive card that includes additional information inquiry button (view history).

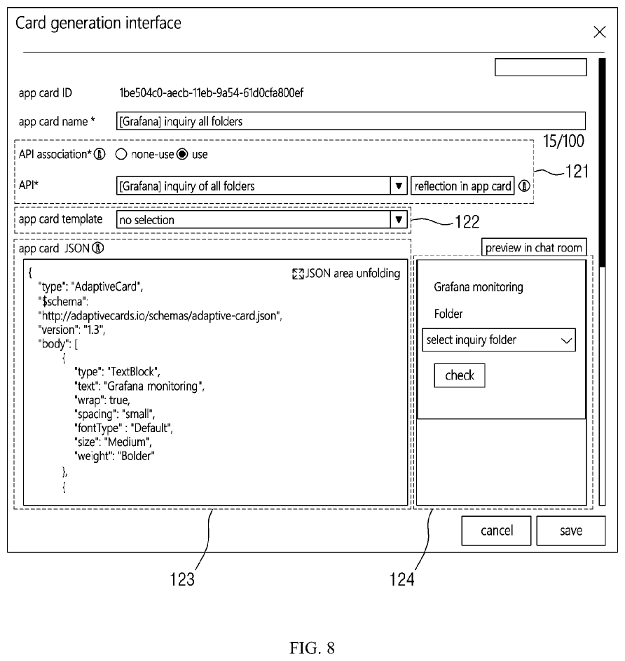

FIG. 8 is a view illustrating an exemplary card generation interface that may be displayed in a user terminal in step S120 to generate the adaptive card illustrated in FIG. 6 or 7.

In some embodiments of the present disclosure, the adaptive card for receiving the control details for the legacy system may involve a call of an API provided by the legacy system. The card generation interface may include an API selection area 121 for designating an API, which is to be bound to the adaptive card, among one or more APIs pre-registered for the legacy system to generate the adaptive card involving an API call. As shown in FIG. 8, the API selection area 121 may include a radio button for selecting whether to call an API and a selection control for selecting an API to be called.

The selection control may be understood to select any one of one or more APIs pre-registered through step S110 as provided by the legacy system. Meanwhile, in some embodiments, the chatbot system may been pre-registered even in the legacy system as a call-enabled system of the API.

The user may load a template through a template selection area 122 included in the card generation interface and then more easily generate an adaptive card based on the template.

Alternately, an advanced user may generate an adaptive card by directly inputting a JSON format syntax representing an adaptive card to a JSON editing area 123 included in the card generation interface.

The card generation interface may include a preview area 124 for previewing the generated adaptive card.

As described above, the API provided by the legacy system may have a type indicating which type of execution result of the API is displayed on the chatbot service.

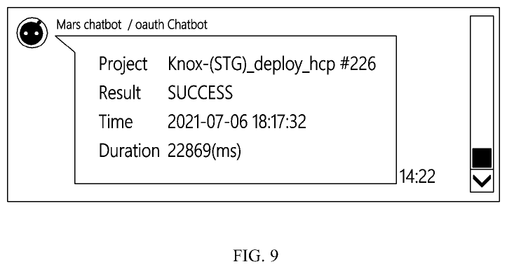

By reflecting the above aspect, when the API of the execution result binding type is selected through the API selection area 121, the card generation interface may newly display an adaptive card generation interface (not shown) of the execution result binding type for additionally registering an adaptive card generated as a chatbot message of the execution result. The adaptive card generation interface of the execution result binding type may be displayed in a space provided as the API selection area 121 is dynamically expanded. FIG. 9 is a view illustrating a situation that an adaptive card of an exemplary execution result binding type is displayed in a chat room with a chatbot.

That is, a user who wants to execute the API of the execution result binding type may register a first adaptive card for receiving parameter information necessary when calling the API and a second adaptive card displayed as an execution result variable of the API is bound, through the card generation interface.

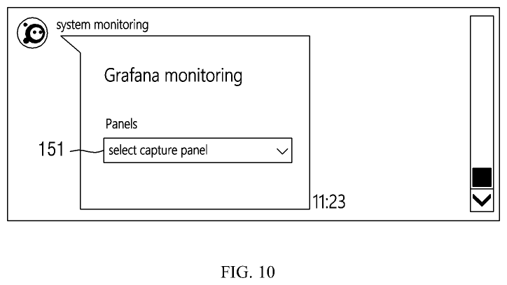

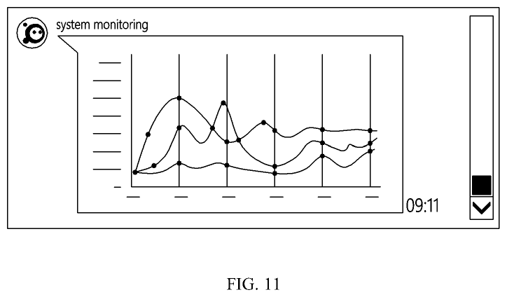

Also, when the API of the capture type is selected through the API selection area 121, the card generation interface may newly display a generation interface (not shown) of an adaptive card for receiving one or more variables for defining a capture screen for the execution result. FIG. 10 is an example of an adaptive card for receiving one or more variables for defining a capture screen for the execution result. When a user selects a capture target panel through a capture panel selection area 151 included in the adaptive card illustrated in FIG. 10, the API of the capture type provided by the control target legacy system is called, and the execution result will be displayed in the chat room with the chatbot in the form of a chatbot message as shown in FIG. 11.

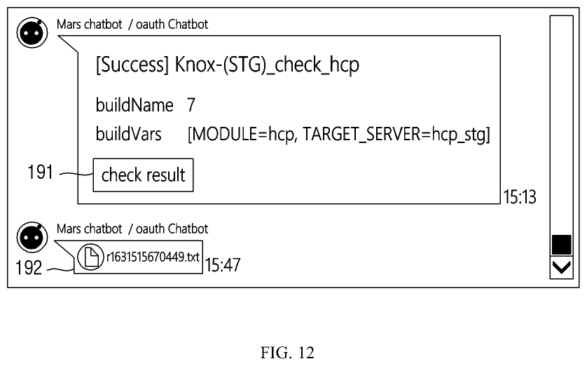

In addition, the API of the execution result download type is selected through the API selection area 121, so that the adaptive card may be generated. In this case, when the adaptive card is selected by a user to control the control target legacy system, the chatbot message of the execution result as shown in FIG. 12 will be displayed in the chat room with the chatbot. That is, a chatbot message including a download button 191 of an API execution result file and a chatbot message 192 additionally displayed when the download button 191 is selected will be displayed in the chat room with the chatbot.

Also, in some embodiments, the API provided by the legacy system may indicate which type of the execution result is displayed on the chatbot service, and the type may be post-designated without being previously designated. That is, the card generation interface may further include an execution result type selection area (not shown) for designating an execution result display type of a call target API selected through the API selection area 121. In this case, the execution result display type may be any one of the execution result binding type, the capture type, and the execution result download type as described above.

As a registration procedure for chatbot-based control of the legacy system, the registration S100 of the control target legacy system, the registration S110 of the API provided by each control target legacy system, and the registration S120 of the card type chatbot interface for inputting control details of the control target legacy system have been described in detail with reference to the examples of FIGS. 6 to 12. Referring back to FIG. 2, an operation in which the user accesses the chatbot service and controls the legacy system will be described.

In step S130, the user terminal accesses the chatbot system and selects a chatbot for controlling the legacy system as a conversation partner, so that a legacy system control dialogue starts. A plurality of users select a control target legacy system from a plurality of connectable legacy systems through the user terminal while progressing a dialogue model of the dialogue (S140), select an adaptive card for controlling the selected control target legacy system, and write control details through the selected adaptive card (S150).

At this time, it has been described that only one adaptive card or a plurality of adaptive cards may be registered in a specific control target legacy system. Also, it has been described that the user may select only an adaptive card previously registered by himself/herself.

In step S160, 2-factor authentication (2FA) is performed, so that the chatbot system may additionally check whether the connected user matches an issue handling person of a legacy system pre-registered by the user. In some embodiments, the 2-factor authentication is performed only when the user terminal is connected to an external network, thereby preventing unnecessary procedures from being performed. When no authentication is passed in the 2-factor authentication, the control procedure for the legacy system will not be performed any longer.

In step S170, it is determined whether a user of the user terminal has a control authority for the control target legacy system. At this time, it is possible to check whether the user of the user terminal has a control authority for the control target legacy system, by using user information of the chatbot service. To this end, a matching table for a legacy system control authority owned for each user information of the chatbot service may be managed. The matching table may be managed by a chatting system or the legacy system. When the user of the user terminal does not have the control authority for the control target legacy system, the control procedure for the legacy system will not be performed any more.

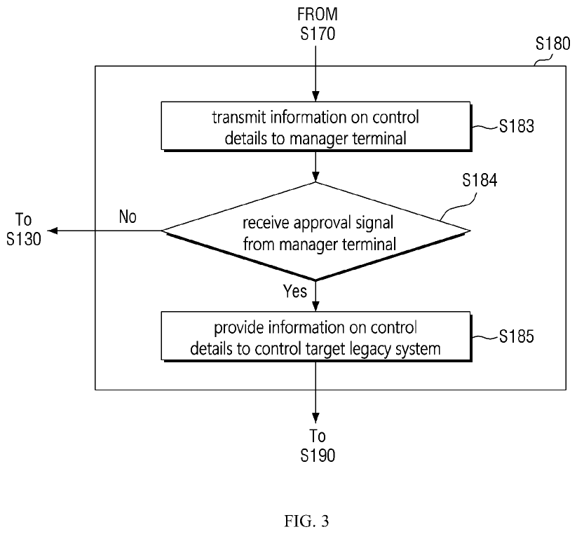

When the user of the user terminal has the control authority for the control target legacy system, information on the control details is provided to the control target legacy system, and the control target legacy system executes a predetermined routine according to the control details (S180). This will be described in more detail with reference to FIG. 3.

In some embodiments, even though the user of the user terminal has the control authority for the control target legacy system, information on control details may be provided to the manager terminal (S183), and the information on control details may be provided to the control target legacy system (S185) only when an approval signal is received from the manager terminal (S184). That is, the control of the legacy system through the chatbot service may be executed through approval of the manager. In this way, the control of the legacy system based on mistakes by the person in charge may be avoided through approval of the manager.

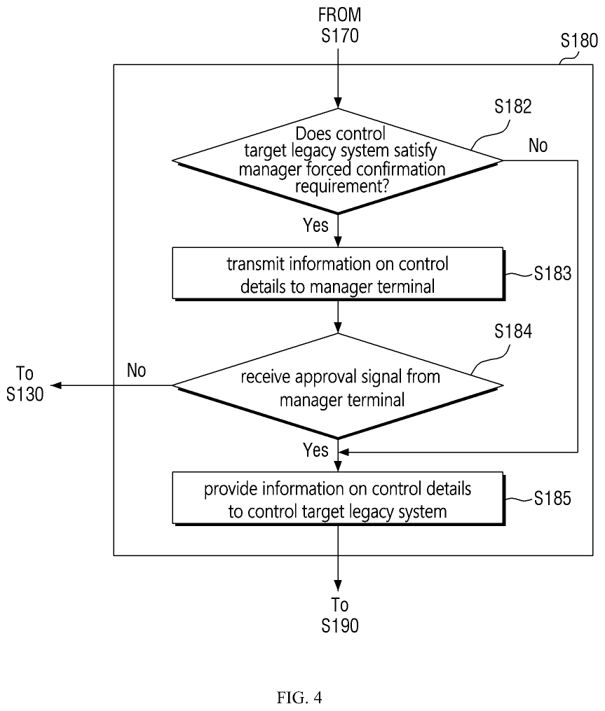

In some embodiments, the legacy system control based on the chatbot service may be performed through approval of the manager only when the control target legacy system satisfies a predefined manager forced confirmation requirement, as shown in FIG. 4 (S182). That is, whether a manager approval procedure should be performed may be a determination dependent on the control target legacy system. When the control target legacy system does not satisfy the predefined manager forced confirmation requirement (S182), the information on control details may be directly provided to the control target legacy system without through manager approval (S185).

For example, when the control target legacy system is included in a list of the legacy system for predefined manager forced confirmation, the manager approval procedure may be performed. For example, when the control target legacy system is a legacy system for controlling an enterprise system, such as a Cl/CD, the manager approval procedure may be performed.

Also, for example, the chatbot system checks an attribute as to checking of a chatbot-based control manager among attributes of the control target legacy system from configuration information, and, as a result of checking, when the attribute as to checking of the chatbot-based control manager of the first legacy system has a pre-designated value, it may be determined that the control target legacy system satisfies the predefined manager forced confirmation requirement.

Also, for example, when dashboard information indicating an operation situation of the control target legacy system satisfies a predefined requirement, the manager approval procedure may be performed.

In addition, for example, when a chatbot service-based control history for the control target legacy system satisfies the predefined requirement, the manager approval procedure may be performed.

In this way, considering sensitivity of the influence of the control for the control target legacy system on the entire system, the manager approval procedure may be additionally and selectively performed, whereby mistakes from easily controlling the legacy system based on the chatbot may be avoided in advance.

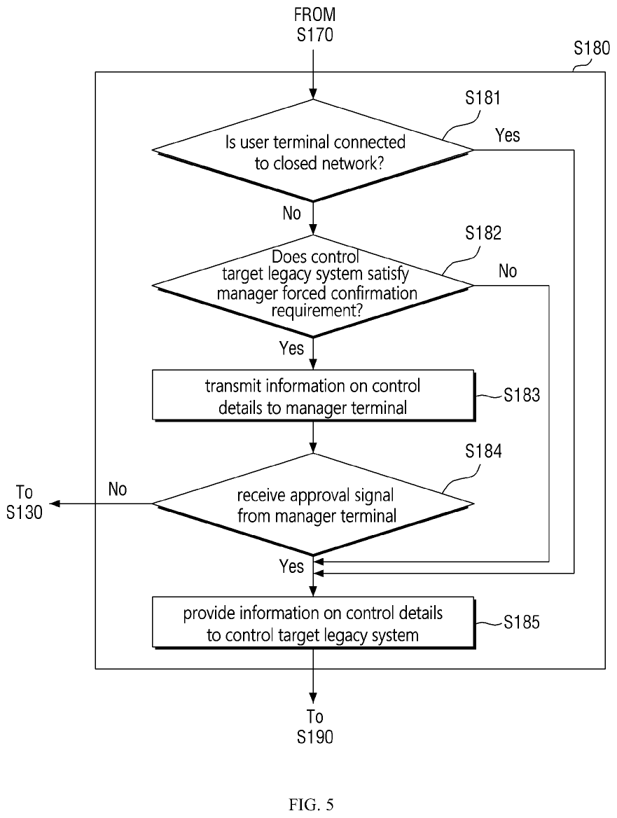

Referring to FIG. 5, the above-described manager approval procedure is performed only when the user terminal is not connected to the closed network (S181), so that the manager approval procedure may be skipped when the person in charge controls the legacy system while working in the company.

Again, the description will be given with reference to FIG. 2. Finally, an execution result is received from the control target legacy system, a chatbot message of the execution result is generated, and the chatbot message of the execution result is output through the chatbot service (S190). An exemplary chatbot message of the execution result will be described with reference to FIGS. 9 to 12. In this case, when the above-described manager approval procedure has been approved, the chatbot message of the execution result may be transmitted to the manager terminal.

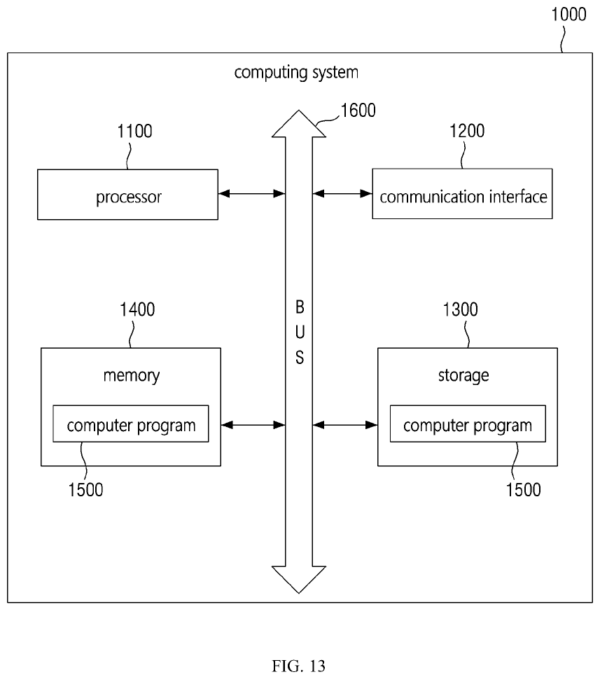

FIG. 13 is a hardware schematic view illustrating a computing system described in some embodiments of the present disclosure. The computing system 1000 of FIG. 13 may include one or more processors 1100, a system bus 1600, a communication interface 1200, a memory 1400 for loading a computer program 1500 performed by the processor 1100, and a storage 1300 for storing the computer program 1500.

The processor 1100 controls the overall operation of each component of the computing system 1000. The processor 1100 may perform an operation for at least one application or program for executing the method/operation according to various embodiments of the present disclosure. The memory 1400 stores various data, commands and/or information. The memory 1400 may load one or more computer programs 1500 from the storage 1300 to execute the method/operations according to various embodiments of the present disclosure. The storage 1300 may non-temporarily store one or more computer programs 1500. The computer program 1500 may include one or more instructions in which the method/operations according to various embodiments of the present disclosure are implemented. When the computer program 1500 is loaded into the memory 1400, the processor 1100 may execute the one or more instructions to perform the method/operations according to various embodiments of the present disclosure.

In some embodiments, the computing system described with reference to FIG. 13 may be configured using one or more physical servers included in a server farm based on a cloud technology such as a virtual machine. In this case, among the components shown in FIG. 6, at least some of the processor 1100, the memory 1400 and the storage 1300 may be virtual hardware, and the communication interface 1200 may be also configured as a virtualized networking component such as a virtual switch.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the example embodiments without substantially departing from the principles of the present disclosure. Therefore, the disclosed example embodiments of the disclosure are used in a generic and descriptive sense only and not for purposes of limitation.

What is claimed is:

1. A method for controlling a legacy system based on a chatbot service, performed in a computing system, the method comprising:
receiving legacy system selection information indicating that a first legacy system is selected as a control target legacy system, from a user terminal through the chatbot service;
receiving control details for the first legacy system from the user terminal through the chatbot service;
transmitting information on the control details to a manager terminal, and transmitting an execution request of the control details to the first legacy system only when an approval signal is received from the manager terminal; and
receiving an execution result of the control details from the first legacy system, and outputting a chatbot message of the execution result through the chatbot service.

2. The method of claim 1, wherein the transmitting the execution request of the control details to the first legacy system includes:
determining whether the first legacy system satisfies a predefined manager forced confirmation requirement;
transmitting the information on the control details to the manager terminal when the control target legacy system satisfies the predefined manager forced confirmation requirement, and transmitting the execution request of the control details to the first legacy system only when the approval signal is received from the manager terminal; and
transmitting the execution request of the control details to the first legacy system when the control target legacy system does not satisfy the predefined manager forced confirmation requirement.

3. The method of claim 2, wherein the determining whether the first legacy system satisfies the predefined manager forced confirmation requirement includes determining that the first legacy system does not satisfy the predefined manager forced confirmation requirement when the user terminal is connected to a closed network.

4. The method of claim 2, wherein the determining whether the first legacy system satisfies the predefined manager forced confirmation requirement includes:
checking an attribute as to checking of a chatbot-based control manager among attributes of the first legacy system from configuration information; and
as a result of checking, when the attribute as to checking of the chatbot-based control manager of the first legacy system has a pre-designated value, determining that the first legacy system satisfies the predefined manager forced confirmation requirement.

5. The method of claim 1, wherein the outputting the chatbot message of the execution result through the chatbot service includes transmitting a message reporting the execution result to a terminal of the manager.

6. The method of claim 1, wherein the determining whether the first legacy system satisfies the predefined manager forced confirmation requirement includes:
checking whether a user of the user terminal has a control authority for the first legacy system by using user information of the chatbot service; and
determining whether the first legacy system satisfies the predefined manager forced confirmation requirement only when the user of the user terminal has the control authority for the first legacy system.

7. The method of claim 1, wherein the first legacy system is a system connected to a closed network distinguished from an external network, to which the user terminal connected to the chatbot service is connected, by one or more firewall systems.

8. The method of claim 1, wherein the first legacy system is a system connected to a closed network, and the receiving the control details for the first legacy system includes:
determining whether the user terminal connected to the chatbot service is connected to an external network distinguished from the closed network by one or more firewall systems;
performing 2-factor authentication (2FA) for the user terminal when the user terminal is connected to the external network; and
outputting an error message through the chatbot service when it is determined that the 2FA is failed.

9. The method of claim 8, wherein the performing the 2FA for the user terminal includes skipping the 2FA when the user terminal is connected to the closed network.

10. The method of claim 1, wherein the receiving the control details for the first legacy system includes receiving a selection input for the first legacy system through the chatbot service as a response to display of a list of a plurality of connectable legacy systems through the chatbot service.

11. A method for controlling a legacy system based on a chatbot service, performed in a computing system, the method comprising:
providing a card generation interface for registering a card type chatbot interface for receiving control details for a first legacy system to a user terminal;
providing the registered card type chatbot interface on the chatbot service in response to receiving the control details for the first legacy system from the user terminal through the chatbot service;
transmitting control details description data generated using information input from the user terminal, to the first legacy system through the card type chatbot interface; and
receiving an execution result of the control details described in the control details description data from the first legacy system and outputting a chatbot message of the execution result through the chatbot service.

12. The method of claim 11, wherein the card type chatbot interface is an adaptive card type interface represented by JavaScript Object Notation (JSON) and rendered by a client application of the chatbot service.

13. The method of claim 11, wherein the providing the registered card type chatbot interface on the chatbot service includes providing any one of card type chatbot interfaces registered by a user of the user terminal on the chatbot service with the user of the user terminal.

14. The method of claim 11, wherein the card generation interface includes an application programming interface (API) selection area for designating an API to be bound to the card type chatbot interface, among one or more APIs pre-registered with respect to the first legacy system,
one or more APIs pre-registered with respect to the first legacy system is provided by the first legacy system, and a system providing the chatbot service is pre-registered as an API call-enabled system.

15. The method of claim 14, wherein the providing the card generation interface for registering the card type chatbot interface to the user terminal includes displaying a generation interface of an execution result binding card for registering the card type chatbot interface generated as the chatbot message of the execution result when an API of an execution result binding type is selected through the API selection area.

16. The method of claim 14, wherein the providing the card generation interface for registering the card type chatbot interface to the user terminal includes displaying an interface for receiving one or more variables for defining a capture screen for the execution result when an API of a capture type is selected through the API selection area.

17. The method of claim 14, wherein the outputting the chatbot message of the execution result through the chatbot service includes outputting the chatbot message of the execution result including a download button of a download file with respect to the execution result when an API of an execution result download type is selected through the API selection area.

18. The method of claim 14, wherein the card generation interface for registering the card type chatbot interface includes an execution result type selection area for designating a type indicating the execution result of the API selected through the API selection area as one of an execution result binding type, a capture type and an execution result download type,
the execution result binding type is a type in which an execution result binding card to which a return value of the selected API is bound is generated as the chatbot message of the execution result,
the capture type is a type in which a capture screen of an execution result screen of the selected API on the first legacy system is generated as the chatbot message of the execution result, and
the execution result download type is a type in which a button capable of downloading a file in which data generated as an execution result of the selected API is written is included in the chatbot message of the execution result.

19. A control system of a legacy system, the control system comprising:
one or more legacy systems in which a chatbot service system is registered as a control permission system capable of transmitting information on control details; and
a chatbot service system configured to perform a dialogue for selecting a control target legacy system among the one or more legacy systems, display a card type chatbot interface for receiving control details for the selected control target legacy system, transmit information on the control details to a manager terminal of a first legacy system when the first legacy system is selected as the control target legacy system, transmit an execution request of the control details to the first legacy system only when an approval signal is received from the manager terminal, receive an execution result of the control details from the first legacy system, and output a chatbot message of the execution result through a chatbot service.

20. The control system of claim 19, wherein the one or more legacy systems are systems connected to a closed network connected to an external network by one or more firewall systems, and
the chatbot service system is a system connected to the closed network.

21. The control system of claim 20, wherein the chatbot service system determines whether a user terminal connected to the chatbot service is connected to the closed network, and performs 2-factor authentication (2FA) for the user terminal when the user terminal is not connected to the external network.

22. The control system of claim 19, wherein the chatbot service system determines whether a user of a user terminal has a control authority for the first legacy system, by using user information of the chatbot service, and determines whether the first legacy system satisfies a predefined manager force confirmation requirement only when the user of the user terminal has the control authority for the first legacy system.
